(19) United States
(12) Patent Application Publication
(10) Pub. No.: US 2012/0284187 A1
(43) Pub. Date: Nov. 8, 2012

(54) SYSTEM AND METHOD FOR PROCESSING PAYMENT TRANSACTIONS

(76) Inventors: Ayman Hammad, Pleasanton, CA (US); Patrick L. Faith, Pleasanton, CA (US); Mark Carlson, Half Moon Bay, CA (US)

(21) Appl. No.: 13/420,377

(22) Filed: Mar. 14, 2012

Related U.S. Application Data
(60) Provisional application No. 61/452,995, filed on Mar. 15, 2011.

(51) Int. Cl. G06Q 20/38; G06Q 40/00

(52) U.S. Cl. 705/44

(57) ABSTRACT

A system and associated data processing flow for processing payment transactions that are conducted using a payment account or portable consumer device. The portable consumer device may be in any suitable form, including cards, key fobs, devices containing a contactless element, smart cards (having contacts or without contacts), etc. The invention separates the authentication of the payment account or payment device from the transaction authorization process, enabling different entities to be responsible for each of those functions.

### CROSS-REFERENCES TO RELATED APPLICATIONS

This application claims the benefit of U.S. Provisional Application No. 61/452,995, entitled “System and Method for Processing Payment Transactions Conducted Using Consumer Payment Devices,” filed Mar. 15, 2011 (Attorney Docket No. 79900-797894 (091910US)), the entire disclosure of which is hereby incorporated herein by reference.

### TECHNICAL FIELD

Embodiments of the invention are directed to systems, apparatuses, devices, and methods for enabling the use of payment accounts and payment devices, and to the processing of transactions conducted using such accounts or devices. More specifically, embodiments of the invention relate to a system and one or more data processing flows for processing payment transactions that are conducted using a payment account, where information regarding the account may be obtained from a portable consumer device. In some embodiments of the invention, validation or authentication of the account or consumer device is separated from the transaction authorization process, enabling different entities to be responsible for each of the two functions.

In some embodiments, this may permit use of a portable consumer device (such as a payment device) developed by one payment processing organization with a transaction authorization process implemented by a second and different payment processing organization. In this way the desirable features of a particular device (or those associated with a particular type of payment account) may be used with multiple payment processing organizations or networks (where such desirable features may relate to aspects such as security, access control, data management, etc.). This may serve to increase the adoption of a standardized or optimal type of device, account feature, or security protocol, while providing the flexibility of using the account or device with multiple payment processing organizations.

### BACKGROUND

Portable consumer (payment) devices such as debit cards or credit cards are used by millions of people worldwide to facilitate various types of commercial transactions. Such payment devices are typically associated with a payment account that contains funds used by a consumer to pay for purchases of a product or service. These transactions generate a significant amount of transaction fees and processing fees, and as a result, a very competitive market exists for the issuance and management of payment devices and payment accounts. This has resulted in a large variety of payment devices, payment device features, payment account characteristics, pricing strategies, incentive programs for consumers, loyalty programs, and other features or benefits intended to differentiate an issuer's payment device or a payment processor's services in the marketplace. Such features or benefits are used to target specific intended users of the payment devices and services, and thereby encourage adoption of a specific payment device, type of payment account, or another financial product or service offered by an issuer, payment processing organization, or other entity.

One concern of consumers when using a payment device or payment account is the degree of security that is provided during a payment transaction. A consumer wants assurance that their financial account information, as well as information about the payment transaction, will remain confidential and not be subjected to discovery and misuse. This includes such information as account numbers, passwords, and the details of transactions that they conduct. As a result of competition within the market for issuing payment devices and processing payment transactions, a variety of such devices and account features have been developed, some with specific security capabilities. These security capabilities include different security features and protocols that may be associated with a specific device or account but not with other devices or accounts. Another area in which a consumer may have a preference with regards to using a specific payment device or account is that of a rewards program offered with an account. A consumer may prefer that all transactions be carried out using an account that has a program they are most interested in using, rather than a program associated with another account.

However, in some cases a certain payment device or account feature is tied to use with a specific payment processing organization (e.g., Visa or MasterCard). This may result because the payment processing organization developed or otherwise supported development of a specific device or account feature. Unfortunately, this may prevent a consumer from having access to the payment device or account features they desire or would prefer to use when conducting payment transactions.

What is desired are systems, apparatuses, devices, and methods for conducting and processing payment transactions that permit a consumer to utilize a payment device or account of their choice with a payment processing network of their choice. Embodiments of the invention address these problems individually and collectively.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

Embodiments of the invention are directed to a system and associated apparatuses, devices, and data processing flows for processing payment transactions that are conducted using a payment account or portable consumer device (such as a payment device). The portable consumer device may be in any suitable form or form factor, including a standard credit or debit card, a key fob, a device containing a contactless element (such as a mobile phone), a smart card (having contacts or communicating using a contactless mode), etc.

Although in some portions of the description of embodiments of the invention, reference will be made to a portable consumer device or payment device, it should be understood that this is not meant to limit the invention to use with such devices, or to require that the invention be practiced with such a device. Because such a device is typically associated with a payment account, presentation of the device by a consumer permits a point of sale terminal to obtain information regarding the payment account that is stored in the device. Thus, for purposes of some embodiments of the invention, presentation of a payment device or acquisition of data from a payment device may be considered to fulfill substantially the same function (or part of the same function) as a consumer providing information about their payment account by another suitable method (or a merchant data processing system obtaining payment account data via a method other than from presentation of a payment device at a point of sale terminal).

In some embodiments, the invention functions to separate the validation (e.g., the verification or authentication) of a payment account and/or payment device from the transaction authorization process, thereby enabling different entities to be responsible for each of those functions. In some embodiments, this may permit use of a portable consumer device or payment account developed by one payment processing organization with a transaction authorization process implemented by a second and different payment processing organization. In this way the desirable security, access control, rewards program, data management, or other features of a particular portable consumer device or account may be used with multiple payment processing organizations or networks. This may serve to increase the adoption of a standardized or optimal type of account, device, or device security protocol, while providing the flexibility of using the account or device with multiple payment processing organizations (and thereby provide consumers with greater freedom to select the combination of device, account, and transaction processing features that they desire).

By separating the payment account or payment device verification operations from the transaction authorization operations, embodiments of the invention provide consumers with greater freedom to conduct transactions using the account or device features they may prefer for purposes of security, reliability, or ease of use. At the same time, merchants and consumers are able to utilize the payment processing organization or network they prefer (for reasons of cost, efficiency, or to obtain other business-related benefits) without sacrificing the ability to use those desirable device features. Similarly, issuers are able to use the device form factor and features they prefer instead of being tied to a portable consumer or payment device that is associated with a particular payment processing organization. In addition, by separating the account/device related operations from the transaction processing operations, the invention supports the development of a standard form for the device and for the functions of the device, or for certain attributes of a payment account. By decoupling the account/device verification from the transaction processing operations, the invention provides a path for the independent development of account and device features that are not tied to any particular payment processing organization but instead provide the security and operating features desired by consumers.

In one embodiment, the invention is directed to a method of processing a payment transaction, where the method includes:
performing, by an entity, an authentication process on payment account data for a payment account used to conduct the payment transaction by processing the payment account data to generate an indication of whether the payment account is a valid payment account;
performing, by a payment processing network, a transaction processing operation by processing data regarding the payment transaction, the transaction processing operation being other than the authentication process to generate an indication of whether the payment account is a valid payment account that is performed by the entity, the payment processing network being operated by a payment processing organization that is different from the entity performing the authentication process; and
providing the results of the processing by the entity and the processing by the payment processing network to an issuer to enable the issuer to approve or deny the payment transaction.

In another embodiment, the invention is directed to a system for processing a payment transaction, where the system includes:
a merchant data processing system configured to receive payment account data from a consumer and in response to generate a request for authorization of the payment transaction;
an entity configured to receive the payment account data and to process the received data to determine whether the payment account is a valid payment account;
a payment processing network operated by a payment processing organization and configured to receive the request for authorization of the payment transaction and to process the request to determine if the payment transaction should be authorized; and
an issuer configured to receive an output from the entity and from the payment processing network and to process the received outputs to determine whether to approve or deny the payment transaction.

In yet another embodiment, the invention is directed to a method of processing a payment transaction, where the method includes:
receiving, from a first payment processing network operated by a first payment processing organization, confirmation that a payment account used to conduct the payment transaction is a valid payment account;
processing, by a second payment processing network operated by a second payment processing organization, an authorization request message for the payment transaction to determine if the payment transaction is authorized; and
providing the confirmation that the payment account is a valid payment account and the determination of whether the payment transaction is authorized to an issuer.

Other objects and advantages of the present invention will be apparent to one of ordinary skill in the art upon review of the detailed description of the present invention and the included figures.

### BRIEF DESCRIPTION OF THE DRAWINGS

FIG. 1 is a functional block diagram illustrating the primary functional elements of an exemplary system for conducting an electronic payment transaction and processing payment transaction data that may be used in implementing an embodiment of the invention;

FIG. 2 is a flow diagram (FIG. 2(A)) and flow chart (FIG. 2(B)) illustrating the process flow for validating a payment account/device and authorizing a transaction in the case of a single payment processing organization being used to conduct and process the transaction;

FIG. 3 is a diagram illustrating an exemplary process flow for validating a payment account/device and authorizing a payment transaction in accordance with an embodiment of the invention;

FIGS. 4-11 are flow diagrams and flow charts illustrating the process flow for validating a payment account/device and authorizing a payment transaction in exemplary embodiments of the present invention;

FIG. 12 is a diagram illustrating certain functional elements of a Portable Consumer (Payment) Account or Device Validation/Authentication Entity (such as is identified as “Device/Account Validation” in the figures) that may be used in implementations of an embodiment of the invention; and

FIG. 13 is a block diagram of elements that may be present in a computing device or system configured to execute a method or process in accordance with an embodiment of the invention.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

As noted, portable consumer (payment) devices such as debit cards or credit cards are used by millions of people worldwide to facilitate various types of commercial transactions. These transactions generate a significant amount of transaction fees and processing fees, and as a result, a very competitive market exists for the issuance and management of payment devices and accounts. This has resulted in a large variety of payment devices, payment device features, payment account characteristics, pricing strategies, incentive programs for consumers, loyalty programs, and other features or benefits intended to differentiate an issuer's payment device or a payment processor's services in the marketplace. Such features or benefits are used to target specific intended users of the payment devices and services, and thereby encourage adoption of a specific payment device, type of payment account, or another financial product or service offered by an issuer, payment processing organization, or other entity.

One area in which new products have been developed is that of portable consumer devices that may be used as payment devices, specifically payment devices that provide ease of use for consumers. One such type of device is a device that includes a contactless element, although it is noted that embodiments of the invention may be used with portable consumer devices that include a contactless element as well as those that lack a contactless element. Incorporating a contactless element into a card, substrate, key fob, mobile phone, or other portable device permits a consumer to interact with a merchant's point of sale (POS) terminal more quickly while retaining possession of the payment device. This improves the security of the transaction since the payment device is not in the possession of someone other than the consumer who may attempt to use it for a fraudulent purpose. Further, as part of conducting the transaction, the contactless element may provide data to a merchant's, issuer's, or payment processing organization's data processing system to permit the payment device to be authenticated. If desired, the data obtained from the contactless element may be used to provide additional access control or security features for the transaction, such as by providing a cryptographic key that is used to identify the device, identify the transaction, or encrypt data involved in the transaction.

With this background, embodiments of the invention may include one or more of the following concepts, features or elements:
(a) an entity that is responsible for validating or otherwise verifying the authenticity of a portable consumer payment device and/or payment account, where such an entity may be a developer of the payment device or a processor of data used in the validation process. For example, the entity responsible for validating the payment device and/or payment account and establishing the validation procedures may be an organization (e.g., Visa) that developed the device or the features of the account. Such an organization may have also defined the functions, operations, and communication protocols used to facilitate payment transactions that are conducted using the payment device or payment account;
(b) a second, and in some embodiments, different entity that is responsible for implementing the operations, functions, or processes used to authorize (and otherwise process) a payment transaction conducted using the payment device or payment account (where, for example, these operations may include those related to settlement and clearance of a transaction). For example, the second entity may be a payment processing organization or network, such as MasterCard, American Express, Discover, etc.; and
(c) a data processing flow (or flows) for performing a payment device and/or payment account validation/authentication process and a payment transaction authorization process, where in some embodiments, the two processes are performed by different entities. The order in which the two processes are performed may vary between embodiments (i.e., in some embodiments, device or account validation may be performed prior to transaction authorization, while in others the order may be reversed) and the entry point for performing each process (i.e., the element or stage of the overall transaction processing at which device or account validation, or transaction authorization is implemented) may also vary between embodiments of the invention.

An example embodiment of the invention will be described with reference to the included figures. However, prior to discussing specific embodiments of the invention, a further description of certain terms is provided to enable a better understanding of the embodiments of the invention and the context in which those embodiments may be implemented.

A “payment device” or “portable consumer device” may include any suitable device capable of being used to provide payment for a transaction (where such a transaction may include a purchase of a product or service). For example, a payment device can take the form of a card such as a credit card, debit card, pre-paid card, charge card, gift card, or any combination thereof. The card or substrate may include a contactless element in which is stored “payment account” data, where the payment account is used to provide funds to pay for services or products purchased by a consumer. Further, a payment device may take the form of a device other than a card which incorporates a data storage element in which is contained data that may be used to conduct a payment transaction. Examples of such devices include mobile phones, PDAs, portable computing devices, etc.

A “payment processing network” (e.g., VisaNet™) is one or more entities (e.g., computing and/or data processing elements) that are capable of communication and data transfer over a suitable communication network or networks, and which is used to perform operations involved in the processing of payment transactions. A payment processing network may include data processing subsystems, networks, and operations used to support and deliver transaction authorization services, consumer authentication services, exception file services, and transaction clearing and settlement services. An exemplary payment processing network may include one or more of the components or elements that are present in VisaNet™. Payment processing networks such as VisaNet™ are able to process credit card transactions, debit card transactions, pre-paid card transactions, and other types of commercial transactions. VisaNet™ in particular, includes a VIP system (Visa Integrated Payments system) which processes authorization requests and a Base II system which performs transaction clearing and settlement services. A payment processing network may use any suitable wired or wireless network, including the Internet, to facilitate communications and data transfer between its component system elements. A payment processing network is typically operated by a payment processing organization (e.g., Visa).

An “authorization request message” (or payment transaction authorization request message) may be generated by an entity (e.g., a merchant) that is part of (or in communication with) a payment processing network as part of the process of obtaining authorization to conduct a payment transaction. Such a message can include a request for authorization to conduct the payment transaction and may include an issuer account identifier. The issuer account identifier may be a payment card account identifier associated with a payment card or may be a payment account identifier obtained from a consumer (or with the consumer's authorization) without the use of a payment device. The authorization request message may request that the issuer of the payment card (or payment device or payment account) authorize a proposed payment transaction. An authorization request message may comply with ISO 8583, which is a standard for systems that exchange electronic transactions conducted by cardholders using payment cards.

An “authorization response message” (or payment transaction authorization response message) may include an authorization code, and is typically produced by an issuer in response to receiving and processing an authorization request message as part of determining whether to approve or deny a requested payment transaction. Other entities or elements that are part of (or in communication with) a payment processing network may also be involved in determining whether to approve or deny a requested transaction.

A “server computer” may be a single computer or a cluster of computers. For example, the server computer may be a large mainframe, a minicomputer cluster, or a group of servers functioning as a unit. In one example, the server computer may be a database server coupled to a Web server. A payment processing network may include one or more server computers.

A “terminal” (e.g. a point-of-service or point-of-sale (POS) terminal) may be any suitable device configured to allow a consumer or merchant to initiate (and in some cases, at least partially process) a payment transaction, such as a credit card or debit card transaction, a prepaid card transaction, a load transaction, or an electronic settlement transaction. The terminal may include optical, electrical, or magnetic elements configured to read data from a portable consumer device such as a smart card, a keychain device, a cell phone, a payment card, a security card, an access card, etc., or allow a consumer or merchant to otherwise enter data concerning a payment account.

An “acquirer” is a business entity (e.g., a commercial bank) that typically has a business relationship with a merchant and receives some or all of the payment transactions conducted with that merchant. The acquirer assists in the authorization and processing of the transactions.

An “issuer” is a business entity which issues a card or other form of payment device to a consumer or card holder. The issuer is typically a financial institution such as a bank, credit union, savings and loan, etc. The issuer assists in the authorization and processing of transactions for consumers, and typically also provides administrative and management services for the payment account associated with the payment device.

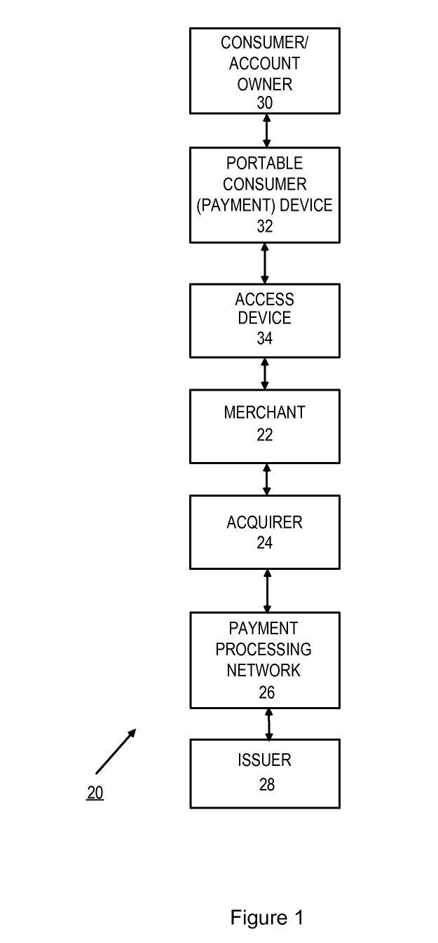

In order to provide an example of the context in which the present invention may be implemented, a brief discussion of the entities involved in processing and authorizing a payment transaction (and their roles in the processing of payment transaction data) will be presented. FIG. 1 is a functional block diagram illustrating the primary functional elements of an exemplary system 20 for conducting an electronic payment transaction and processing payment transaction data, certain elements of which may have a role in implementing and utilizing an embodiment of the invention.

In a typical payment transaction, an account owner (e.g., an individual consumer) provides a payment account or payment device identifier to a merchant or service provider. The payment account or payment device identifier may be provided in the form of a card (e.g., a magnetic stripe card or smart card with an embedded chip) accessed by a point of sale terminal or card reader, by a contactless device embedded in another device (e.g., a mobile phone, PDA, etc.) that communicates with a point of sale terminal using a short range wireless communications technique, or by another suitable form. In some cases a consumer may provide payment account information without use of a payment device, such as by entering data into a suitable data input device.

Typically, an electronic payment transaction is authorized if the consumer conducting the transaction (which is typically the account owner) is properly authenticated (i.e., their identity and their valid use of a payment account is verified) and has sufficient funds or credit to conduct the transaction. Conversely, if there are insufficient funds or credit in the account, or if the payment device is on a negative list (e.g., it is indicated as possibly having been stolen), then an electronic payment transaction may not be authorized.

As mentioned, although in some embodiments of the invention, a consumer's use of a portable consumer device (i.e., a payment device) to conduct a payment transaction will be described, the invention may be implemented without use of a physical device. In such implementations payment account data may be provided by a consumer to a merchant or to a merchant's data processing system by any suitable process, method, operation, etc.

As shown in FIG. 1, in a typical transaction, a consumer/account owner 30 wishing to purchase a good or service from a merchant provides transaction data that may be used as part of a transaction authorization process, typically by means of a portable consumer (payment) device 32. Consumer 30 may utilize a portable device 32 such as a card having a magnetic stripe encoded with account data (e.g., a standard credit card, debit card, or pre-paid card) to initiate the transaction. In an eCommerce (electronic commerce) transaction, the account owner may enter data into a device capable of communicating with a merchant or other element of system 20, such as a laptop or personal computer.

The consumer may also initiate the transaction using data stored in and provided from a suitable form of data storage device (such as a smart card, mobile phone or PDA containing a contactless element, or a transportable memory device). As examples, a card or similar payment device may be presented to a point of sale terminal which scans or reads data from the card or device. A consumer may enter payment account data into a cell phone or other device capable of wireless communication (e.g., a laptop computer or personal digital assistant (PDA)) and have that data communicated by the device to the merchant, the merchant's data processing system, or to a transaction authorization network. A wireless device may also be used to initiate a payment transaction by means of communication between a contactless element embedded within the device and a merchant device reader or point of sale terminal using a short range communications mechanism, such as RF, infra-red, optical, near field communications (NFC), etc. Thus, in some cases an access device 34 may be used to read, scan, or otherwise interact with a payment device or consumer and thereby obtain data used in conducting a payment transaction.

The payment account data (and if needed for processing the transaction, other account owner data) is obtained from the consumer/account owner's device or the consumer, and provided to the merchant 22 or to the merchant's data processing system. The merchant or merchant's data processing system generates a transaction authorization request message that may include data obtained from the payment device as well as other data related to the transaction (or to the merchant). As part of generating the authorization request message, the merchant 22 or the merchant's transaction data processing system may access a database which stores data regarding the account owner, the payment device, or the account owner's transaction history with the merchant.

The merchant transaction data processing system typically communicates with a merchant acquirer 24 (e.g., a commercial bank which manages the merchant's accounts) as part of the overall transaction authorization process. The merchant's transaction data processing system and/or merchant acquirer 24 provide data to Payment Processing Network 26, which among other functions, participates in the clearance and settlement processes which are part of the transaction processing. Payment Processing Network 26 may be operated in whole or in part by a payment processing organization, such as Visa. As part of the transaction authorization process, an element of Payment Processing Network 26 may access an account database which contains information regarding the account owner's payment history, chargeback or dispute history, credit worthiness, etc. Payment Processing Network 26 communicates with issuer 28 as part of the authorization process, where issuer 28 is the entity that issued the payment device to the account owner and provides administrative and management services for the consumer's payment account. Account data is typically stored in an account owner database which is accessed by issuer 28 as part of the transaction authorization and account management processes.

In standard operation, an authorization request message is created during a purchase (or proposed purchase) of a good or service at a point of sale (POS). The point of sale may be a merchant's physical location or may be a virtual point of sale such as a web-site that is part of an eCommerce transaction. In a typical transaction, the authorization request message is sent from the point of sale (e.g., the merchant or the merchant's transaction data processing system) to the merchant's acquirer 24, then to the Payment Processing Network 26, and then to the appropriate issuer 28. An authorization request message may include a request for authorization to conduct an electronic payment transaction. It may include one or more of an account owner's primary account number (PAN), payment device expiration date, currency code, sale amount, merchant transaction stamp, acceptor city, acceptor state/country, etc. An authorization request message may be protected using a secure encryption method (e.g., 128-bit SSL or equivalent) in order to prevent data from being compromised.

Portable consumer (payment) device 32 may be in any suitable form and may incorporate a contactless chip or other element that facilitates payment transactions. For example, suitable payment devices can be hand-held and compact so that they can fit into a wallet and/or pocket (e.g., pocket-sized). They may include contact or contactless smart cards, credit or debit cards (typically with a magnetic stripe and without an embedded microprocessor), pre-paid cards, keychain devices (such as the Speedpass™ which is commercially available from Exxon-Mobil Corp.), and depending upon the specific device, may incorporate a contactless element that is configured to enable the device to participate in payment transactions. Other examples of suitable payment devices include cellular phones, personal digital assistants (PDAs), pagers, payment cards, security cards, access cards, smart media, transponders, and the like, where as noted, such devices may incorporate a contactless element. Depending upon the specific design, the payment device may function as one or more of a debit device (e.g., a debit card), a credit device (e.g., a credit card), or a stored value device (e.g., a stored value or pre-paid card).

Payment Processing Network 26 may comprise or use a payment processing network such as VisaNet™. Payment Processing Network 26 and any communication network that communicates with Payment Processing Network 26 may use any suitable wired or wireless network, including the Internet. Payment Processing Network 26 may be adapted to process debit card, credit card, or pre-paid card transactions, in addition to processing transactions associated with the loading and/or reloading of value on a payment device or portable consumer device (such as a pre-paid card).

As noted, a payment processing network (e.g., VisaNet) may include a plurality of data processing devices, such as computers, servers, or central processing units that are interconnected by a suitable network or networks. The data processing devices may be used to support device or account verification, and transaction authorization, clearing, and settlement services (as described below) for users of the payment processing network, where these services may be applied as needed to various types of transactions:
Payment Device or Payment Account Verification—the necessary functions or operations to enable authentication/validation of a payment device and/or payment account being used to initiate a payment transaction. Such functions or operations may be directed to one or more of determining that the device and/or account is a valid one, that the device and/or account has not been reported as a source of a fraudulent transaction, that the device and/or account is being used in accordance with any prescribed limitations, etc.;
Authorization—the necessary functions or operations to enable an issuer to approve or decline a transaction before a purchase is finalized or cash is disbursed;
Clearing—the necessary functions or operations to support the process of delivering a transaction from an acquirer to an issuer for posting to a consumer's account; and
Settlement—the necessary functions or operations to support the process of calculating and determining the net financial position of each party for all transactions that are cleared.

The device or account verification, and transaction authorization, clearance, and settlement functions are typically performed by exchanging messages between the elements of the payment processing network and the entities that interact with that network (such as the acquirer and issuer). Depending on the function being performed and the type or format of a message, a message may contain one or more of: (a) information about the transaction (e.g., the date, type of transaction, amount of the transaction, the merchant involved, etc.); (b) information about the consumer conducting the transaction (e.g., the consumer's account number, security code, etc.); (c) information about the merchant with whom the consumer is conducting the transaction (e.g., a merchant code or other identification, etc.); or (d) information about the status of the processing of the transaction (e.g., a flag or indicator of whether the transaction has been approved or declined, etc.). A message may also include information about the consumer, merchant, or transaction that is used by the elements of the payment processing network (and/or the entities that interact with that network) to perform their respective data processing functions (e.g., generating a risk or fraud score, etc.). The messages typically have a format or structure in which certain information is found in a defined field or region of the message. In addition to one or more defined fields, a message may also include one or more discretionary fields in which other forms or types of data may be placed.

In a payment processing network such as VisaNet, the primary components are VisaNet Interchange Centers (VICs), VisaNet Access Points (VAPs) and other network connections, and Processing Centers. These components are arranged in an architecture that provides consumers, merchants, acquirers, and issuers with the services needed for authorization, clearance, and settlement of transactions.

A VisaNet Interchange Center (VIC) is a Visa data processing center. Each VIC houses computer systems that perform VisaNet transaction processing. The VIC serves as the control point for the telecommunications facilities of the VisaNet Communications Network, which comprises high-speed leased lines or satellite connections based on IBM SNA and TCP/IP protocols.

A VisaNet Access Point (VAP) is a Visa-supplied computer system (located at a processing center) that provides an interface between the center's host computer and the VIC. The VAP facilitates the transmission of messages and files between the processing center host and the VIC, supporting the authorization, clearing, and settlement of transactions. Visa also provides other connection options for interacting with VisaNet that do not require VAPs.

A processing center is a data processing facility operated by (or for) an issuer or an acquirer. The processing center houses card processing systems that support merchant and business locations, and maintain cardholder data and billing systems. As a form of redundancy, each processing center communicating with VisaNet may be linked to two VICs. Processing centers are connected to the closest, or primary, VIC. If one VIC experiences a system interruption, then VisaNet automatically routes members' transactions to a secondary VIC, thereby ensuring continuity of service. Each VIC may also be linked to one or more of the other VICs. This link enables processing centers to communicate with each other through one or more VICs. Processing centers can also access the networks of other card programs (i.e., non-Visa branded programs) through the VIC.

A VisaNet Interchange Center (VIC) typically houses the following VisaNet systems that provide both online and offline transaction processing:

(1) the VisaNet Integrated Payment (V.I.P.) System, which includes the BASE I System and the Single Message System (SMS);

### (2) the BASE II System; and

### (3) the VisaNet Settlement Service (VSS).

Together, these VisaNet systems perform part or all of the transaction authorization, clearing, and settlement functions.

The V.I.P. System is the primary online transaction switching and processing system for online authorization and financial request transactions that enter VisaNet. V.I.P. has one system that supports dual-message processing (where authorization of transactions is requested in a first message, while financial clearing information is sent in a second message), and another system that supports single-message processing (the processing of interchange card transactions that contain both authorization and clearing information in a single message). In both cases, settlement occurs separately.

BASE I is the component of the V.I.P. System that processes authorization-only request messages online. Authorization request messages are typically the first messages sent in dual-message processing (where BASE II clearing messages are the second messages sent in dual-message processing). The BASE I component of the V.I.P. System supports online functions, offline functions, and the BASE I files. BASE I files include the internal system tables, the BASE I Cardholder Database, and the Merchant Central File. The BASE I online functions include dual-message authorization processing. BASE I online processing involves routing, cardholder and card verification, and stand-in processing (STIP), plus related functions, such as Card Verification Value (CVV) validation, PIN verification, and file maintenance (some of which may be part of verifying or authenticating a payment account and/or payment device).

A bridge from BASE I to SMS makes it possible for BASE I members to communicate with SMS members and to access the SMS gateways (to obtain access to outside networks). The BASE I offline functions include BASE I reporting and the generation of Visa Card Recovery Bulletins. BASE I reporting includes authorization reports, exception file and advice file reports, and POS reports.

The Single Message System (SMS) component of the V.I.P. System processes full financial transactions. Full financial transactions contain both authorization and clearing information. Because the authorization and clearing information is contained in one message, this form of processing is referred to as single-message processing. SMS also supports dual-message processing of authorization and clearing messages, communicating with BASE I and accessing outside networks, as required, to conduct transaction processing.

SMS supports online functions, offline functions, and the SMS files. The SMS files comprise internal system tables that control system access and processing, and the SMS Cardholder Database, which contains files of cardholder data used for PIN verification and for stand-in processing (STIP) authorization. The SMS online functions perform real-time cardholder transaction processing and exception processing. This processing supports both authorizations and full financial transactions. In addition, SMS supports the delivery of transactions to the BASE II System for members that use dual-message processing. SMS also accumulates reconciliation totals, performs activity reporting, and passes activity data to VisaNet, which supports settlement and funds transfer processing for SMS. VisaNet typically handles settlement and funds transfer as an automatic follow-up to SMS transaction processing. The SMS offline systems process settlement and funds transfer requests and provide settlement and activity reporting. They also support an offline bridge to and from BASE II for those Visa and Plus clearing transactions that are sent between an SMS member and a BASE II member.

The BASE II System is an international electronic batch transaction clearing system for the exchange of interchange data between acquirers and issuers. The system calculates interchange fees between members. BASE II performs the second part of dual-message processing. Through a BASE I System connection, members submit authorization messages, which are cleared through a VisaNet connection to BASE II. A bridge to the V.I.P. System permits interchange between BASE II processing centers and SMS processing centers.

The VisaNet Settlement Service (VSS) consolidates the settlement functions of SMS and of BASE II, including Interlink, into a single service for all products and services. Members and processors receive settlement information from SMS and from BASE II in a standardized set of reports. VSS provides flexibility in defining financial relationships, in selecting reports and report destinations, and in establishing fund transfer points. VisaNet processes interchange transactions for SMS and for BASE II through separate systems.

As noted, information passes between members and V.I.P. in the form of messages. For use with VisaNet, BASE I, and SMS, those messages may be variations of the International Organization for Standardization (ISO) 8583 message, which is the international standard for the format of financial messages. Each message may contain a bit map that specifies the data fields that appear in the message, a message type identifier, and those fields that are needed for the specific function intended. The message header contains basic message identifiers and routing information, along with message processing control codes and flags. The message type identifier specifies the message class and the category of the function that is to be implemented. For instance, 0100 may indicate a transaction authorization request. As noted, a bit map specifies which data fields are in a message. In addition to a primary bit map, messages can include secondary (and other) bit maps. Each map typically contains 64-bit fields, corresponding to the number of possible fields in a message. The data fields contain the information needed to process a message.

As mentioned, a portable consumer (payment) device used to conduct a payment transaction may be in any suitable form and may incorporate a contactless element that facilitates payment transactions. When a portable consumer device that is capable of functioning as a contactless payment device is used, the device typically incorporates a contactless chip or similar element that communicates with a merchant's point of sale terminal using a wireless communications protocol or method. This enables a consumer to conduct a transaction while retaining possession of the payment device, thereby reducing the possibility of fraud or other forms of misuse of the payment device or of the data that may be accessed using the device. The security of the transaction (and of account and transaction related data) may also be increased by use of a short range wireless communication method, such as NFC (near field communications), RF, optical, or infra-red technologies. Use of a short range (in some cases one effectively acting only over several inches) wireless communications technology helps to ensure that a payment transaction is only initiated when a consumer intends one to be, while use of a wireless communications technology may permit faster transactions since a payment device does not need to be swiped or physically accessed by a card reader.

Although conducting a payment transaction using a contactless or other form of payment device may be considered secure, some payment devices incorporate additional features to enhance the protection of the account data and transaction data. Such features may include cryptographic protection of data transferred between the payment device and a payment terminal (such as a merchant's point of sale terminal), or use of a cryptographically generated identifier for some aspect of a transaction. For example, the Visa payWave contactless device generates a unique, encrypted code for each transaction. This dynamic code is used by Visa to verify that the payment device is authentic and also to provide an identifier for each transaction. The dynamic code may be provided to an issuer (or other entity) who decrypts it and uses it to confirm that the transaction was initiated using a valid payment device. Thus, the dynamic code serves in whole or in part to authenticate or validate the payment device.

The use of a dynamic cryptogram as part of implementing the payWave payment device is one example of how a payment device may incorporate desirable device validation or transaction verification functions. In this example, each transaction is complemented by a dynamic cryptogram, where that cryptogram may be based on one or more transaction attributes (and which may include a unique counter value that is sequentially generated by the contactless payment device's chip). The dynamic value can be used to verify the presence of a specific contactless chip at a merchant's POS terminal and provides an effective deterrent to counterfeiting.

Typically, a payWave device would be used for transactions that were processed by Visa, as that is the payment processing organization that developed the device and its security features. However, as recognized by the inventors, it would be desirable if aspects of the payWave device (or of another type of portable consumer device that may function as a payment device) and its associated security and transaction processing functions could be used with other payment processing networks as well. This would permit consumers and merchants to obtain the benefits provided by the payWave system's security and payment application functions, while having the ability to use those functions to initiate payment transactions that are processed by multiple payment processing networks. In such cases, Visa (or a first payment processing network) might provide services to verify the authenticity of a payment device or payment account, while a second and different payment processing network might provide the functions used to authorize or otherwise process a payment transaction conducted using the payment device or payment account (such as participating in the clearance and settlement operations).

By separating or decoupling the payment device or payment account verification (i.e., validation or authentication) operations from the payment transaction processing/authorization operations, embodiments of the invention provide consumers with greater freedom to conduct transactions using the account/device features they may prefer for reasons of enhanced security, reliability, or ease of use. At the same time, merchants and consumers are able to utilize the payment processing organization or network they prefer (for reasons of cost, efficiency, or to obtain other business-related benefits) without sacrificing the ability to use the desirable account or device features. Similarly, issuers are able to use the account characteristics and/or device form factor and features they prefer instead of being tied to a payment device that is associated with a particular payment processing organization. In addition, by separating the account/device related operations from the transaction processing operations, the invention may support the development of a standard form for the device and for the functions of the device and/or attributes of a payment account. By decoupling the account/device verification from the transaction processing operations, the invention provides a path for the independent development of account characteristics and/or device features that are not tied to any particular payment processing organization, but instead provide the security and operating features desired by consumers.

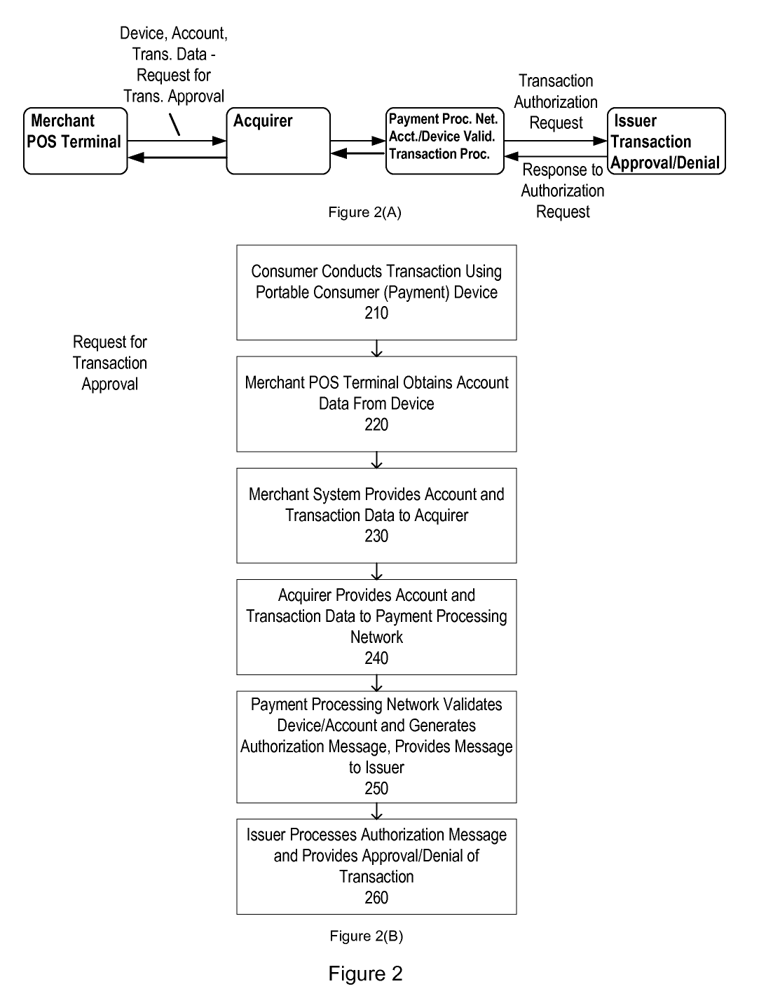

FIG. 2 is a flow diagram (FIG. 2(A)) and flow chart (FIG. 2(B)) illustrating the process flow for validating a payment account/device and authorizing a transaction in the case of a single payment processing organization being used to conduct and process the transaction. Note that the payment account/device may take the form of a portable consumer device, such as a card, key fob, contact or contactless smart card, other device incorporating a contactless element, etc. Note that the process flow shown in FIG. 2 represents the standard process flow, as was described with reference to FIG. 1.

In the process flow shown in FIG. 2, the merchant's POS terminal interacts with the portable consumer (payment) device to obtain information regarding the payment account being used for the transaction (as suggested by process steps 210 and 220 in the FIG. 2(B)). The merchant transaction processing system generates a message or other form of request to approve the transaction (labeled “Device, Account, Transaction Data—Request for Transaction Approval” in FIG. 2(A)). The request to approve the transaction is provided (along with other account or transaction specific data that may be required) to the merchant's acquirer (as suggested by process step 230 in the figure). The acquirer may process the request to add data or information, or create a record of the request for its own purposes before providing the request to the appropriate payment processing network (process step 240), where such a network is typically operated by a payment processing organization (e.g., Visa or MasterCard). The payment processing network processes the request, which may include performing operations to validate or verify the authenticity of the payment account or payment device (such as confirming that it was issued by a recognized issuer, that it has not been reported as stolen, that it has not been tampered with, that it is not a source of fraudulent transactions, to identify specific limitations or restrictions on an account, etc.).

The payment processing network may also generate an authorization request message for the transaction (or add data to a message provided by the merchant or acquirer) that is sent to the issuer that manages the payment account associated with the payment device (process step 250). The authorization request message may contain data or information about the payment device (such as the results of the verification/validation process), about the transaction (such as the amount, merchant category type, etc.), or about the payment account being used for the transaction (such as its risk profile, history, status, etc.). These operations are indicated by the element labeled “Payment Processing Network, Account/Device Validation, Transaction Processing” in FIG. 2(A). The authorization request message (labeled “Transaction Authorization Request” in FIG. 2(A)) is received by and processed by the issuer, which determines if the transaction should be approved or denied (process step 260). The approval or denial decision is provided in an authorization response message that is generated by the issuer (labeled “Response to Authorization Request” in FIG. 2(A)) and sent to the payment processing network, and from there to the acquirer and eventually to the merchant (who can inform the consumer if the transaction is denied). In addition to generating or modifying a transaction authorization request message, the payment processing network may also perform other data processing operations related to the transaction. Such data processing operations may include performing an evaluation of the risk or fraud associated with the transaction, or providing information to the issuer that will be used in deciding whether to approve or deny the transaction.

Note that in the system and processes described with reference to FIG. 2, a single entity (e.g., a payment processing network operated by a payment processing organization such as Visa) is responsible for both the account/device validation and the transaction processing/authorization aspects of the overall process. This means that the entity responsible for authenticating the payment device or payment account is also responsible for one or more of the transaction processing operations (such as risk evaluation, authorization, etc.). Another way of phrasing this is to say that the payment processing organization responsible for the payment transaction processing is also responsible for conducting at least some of the operations used to validate the payment account or payment device. This dual set of functions is typically found where a payment processing organization has contributed to creating the device and/or defining its functionality. For example, a payment processing organization may create a portable consumer (payment) device and/or define its functionality in order to ensure that the device is compatible with its payment processing network and data processing systems, to enable others (e.g., consumers, merchants, or issuers) to be provided with desirable features or device capabilities, or for another relevant business reason.

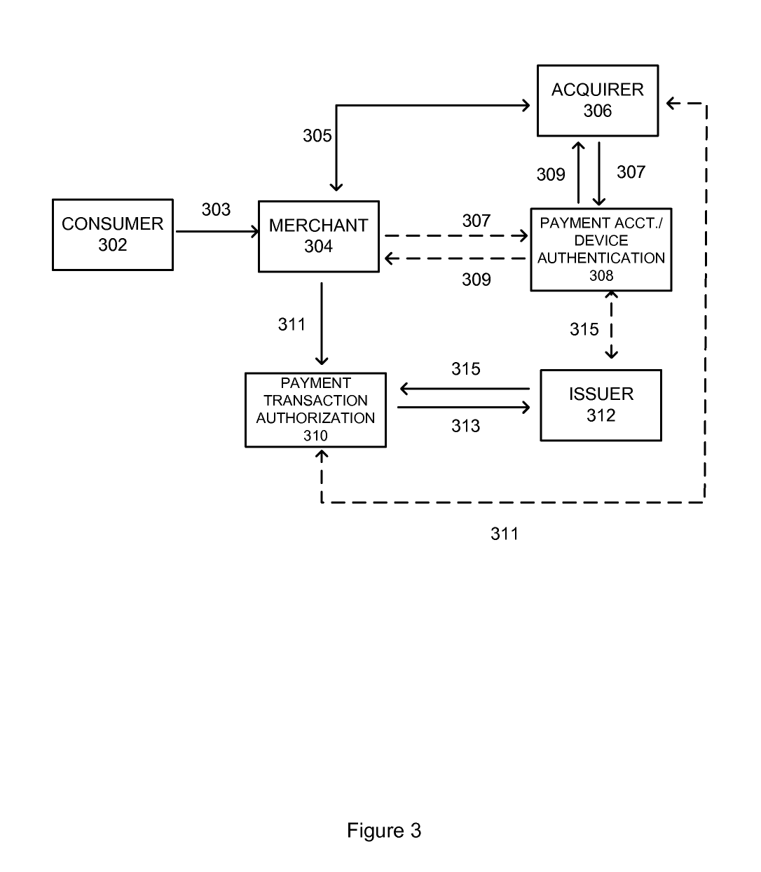

FIG. 3 is a diagram illustrating an exemplary process flow for (a) authenticating/validating a payment account/device and (b) authorizing a payment transaction in accordance with some embodiments of the present invention. As shown in the figure, a consumer/account owner 302 may initiate a payment transaction by presenting their portable consumer device (e.g., a payWave enabled payment device) to a merchant 304 (as indicated by path 303). Merchant 304 obtains the data needed to initiate the transaction from the payment device and may provide that data to their acquirer 306 (as indicated by data transfer path 305). Merchant 304 may also obtain the data needed to initiate the transaction from the consumer without the presentation of a payment device, in which case the consumer may provide payment account information by another means. Merchant 304 or their acquirer 306 then initiates an authentication/validation operation (identified as “Payment Account/Device Authentication 308” in the figure) for the payment account/device (as indicated by paths 307) that functions to authenticate, verify, or otherwise validate the account/device. Authentication process 308 may be performed by a developer of the payment device, a developer of certain aspects of the payment account, or by another entity. If performed by an entity other than the developer, then the authentication process may be performed using an authentication/validation module provided to it by the developer of the device or account. The authentication/validation module may contain instructions that control a processor and cause the processor to implement one or more functions, operations, processes, or methods used in authenticating the payment device or payment account.

For example, in the case of a payWave device, this might involve communication with Visa (such as by sending a message over the Visa network) to request that Visa validate the payment device and verify that it is a valid payWave device. For this example, Visa would verify that the cryptogram or other data provided by the device was a valid one and hence that the device itself was an authentic payWave device. Visa would then send confirmation of the validity of the device back to acquirer 306 or merchant 304 (depending on which party requested the device authentication process, and as indicated by paths 309). Note that if the confirmation was sent to acquirer 306, it might be routed by the acquirer to merchant 304 (or vice-versa).

In the absence of a physical payment device, authentication entity 308 may perform other types of validation operations (note that some or all of these may also be performed in addition to a device validation process, such as the cryptogram processing noted). Such payment account validation operations or processes include: (a) analysis of account usage statistics (such as velocity of transactions, etc.) to determine an indication of unusual activity within the account as represented by the current transaction or previous transactions; (b) the IP address or other indication of the source of the transaction; (c) requesting that the consumer respond to a real-time challenge or security question; (d) analysis of data related to the type of transaction (such as if it is a cash transfer, or evidence of previous cash transfers using the account that might indicate misuse of the account); (e) the presence or absence of a unique “key” or other type of data in the data provided by the device or the consumer; or (f) other indicia of the account, the consumer, the merchant, or the transaction that might suggest an attempt to commit a fraudulent transaction.

Upon receipt of data confirming the validity of the payment device or payment account, acquirer 306 or merchant 304 provides data regarding the transaction to a second and different entity (such as a second payment processing network) for purposes of authorizing/processing the transaction (identified as “Payment Transaction Authorization 310” in the figure, and where the transfer of the data is indicated by paths 311). The second entity performs the payment transaction authorization operations (and may perform other transaction processing as well), which typically include generation of one or more messages requesting authorization of the payment transaction. The transaction authorization request message(s) (indicated as data transfer path 313) are provided to issuer 312. Issuer 312 determines whether to approve or deny the transaction and provides that decision in the form of a transaction authorization response message to the relevant entity or entities (indicated as data transfer paths 315). This entity or entities may include one or more of (a) the entity 308 that performed the payment account/device authentication (which, if a payment processing network such as Visa may route the transaction authorization response message to Acquirer 306 (e.g., along data path 309), from which the decision may be provided to Merchant 304 (e.g., along data path 305)), or (b) the entity 310 that generated the payment transaction authorization request message (which, if a payment processing network may route the transaction authorization response message to Acquirer 306 (e.g., along data path 311) from which the decision may be provided to Merchant 304 (e.g., along data path 305)).

Thus, in the system and process flow depicted in FIG. 3, a first entity is responsible for verifying the authenticity of the payment account and/or payment device (the entity represented by payment account/device authentication operations 308), while a second and different entity is responsible for authorizing/processing the payment transaction (the entity represented by payment transaction authorization operations 310). From another perspective, in some embodiments, the entity that authenticates the payment account/device does not participate in processing the transaction, while the entity that processes the transaction does not participate in authenticating the payment account/device.

Another perspective is that at least some of the payment account/device authentication operations are performed by an entity that does not participate in processing the transaction, and that at least some of the payment transaction processing operations are performed by an entity that does not participate in the payment account/device authentication operations. Or still further, that a first entity performs certain payment account and/or payment device authentication operations needed to conduct and process a payment transaction, where those operations are not performed by a second entity. And that the second entity performs certain transaction processing operations that are needed to conduct and process the payment transaction, where those operations are not performed by the first entity. As an example, in one embodiment, the first entity may be a first payment processing organization (such as Visa) and the second entity may be a second payment processing organization (such as MasterCard).

Note that entity 308 and entity 310 may exchange data or information with each other, either directly or indirectly via a common entity (such as Acquirer 306, Merchant 304, or Issuer 312). In some embodiments, entity 308 may provide a result of its payment account and/or payment device authentication processing in the form of a message or data file that is sent to Issuer 312, Acquirer 306, or entity 310 (or if not provided directly to entity 310, provided as part of other messages or data provided to entity 310 by another entity). The message or data file may be in the form of setting a flag in (or adding a code to) a standard message (such as an ISO 8583 message), generating an email message containing a result that can be interpreted by entity 308 (or by another entity in the processing flow), expressing the result in the form of a markup language page, etc. Thus, in order for entity 310 to process a transaction authorization request that includes a result of entity 308 performing an authentication operation, it may be necessary for the output from entity 308 to be converted, re-formatted, mapped, or otherwise processed to enable entity 310 to interpret that output.

For example, entity 308 may communicate the result of its authentication processing by providing a code representing a result of the authentication processing. The code may be included in an email, a markup language version of a web page, a field of a data message, etc. The output of entity 308 may then need to be interpreted, converted, enhanced by the addition of other data, etc. to enable entity 310 to utilize the information. This may involve parsing of a received message, followed by mapping of data in the message to another format, followed by generation of a new message.

For example, a server may be used to receive the output of entity 308. The server may be operated by entity 308 (such as a payment processing organization) or by a different entity (such as a third party provider of a device or service). The data received by the server may include a transaction identifier to enable all data related to the transaction to be accessed, combined, and processed by different entities as needed. Based on the received data, other data may need to be provided in order to facilitate transaction processing by entity 310 (a process sometimes referred to as data “enhancement”). Such other data may be obtained using a lookup table or mapping, where the other data may be a consumer's name or zip code, for example. In some situations, data may need to be translated to another format, such as translating an IP address from the format in which it is received in one message (such as XML) into the format in which it can be interpreted in another message or in accordance with a different protocol (such as 3D Secure, binary, a “hash” of the data, etc.). Similarly, if used, the encryption and decryption of data and messages may be performed in accordance with or under the control of any suitable algorithm, protocol, or process. These include, but are not limited to, AES, Elliptical non-symmetric key encryption, RSA, SHA-1, SHA-2, use of hash phrases, limited use keys (e.g., time-limited, event-limited, device-limited, etc.), etc. In cases in which a key or other data needs to be provided to a consumer, a key injection protocol may be used to accomplish that operation. Note that other suitable processes for enabling an output of entity 308 to be used by entity 310 are possible and are understood to be part of the underlying concepts of the invention.

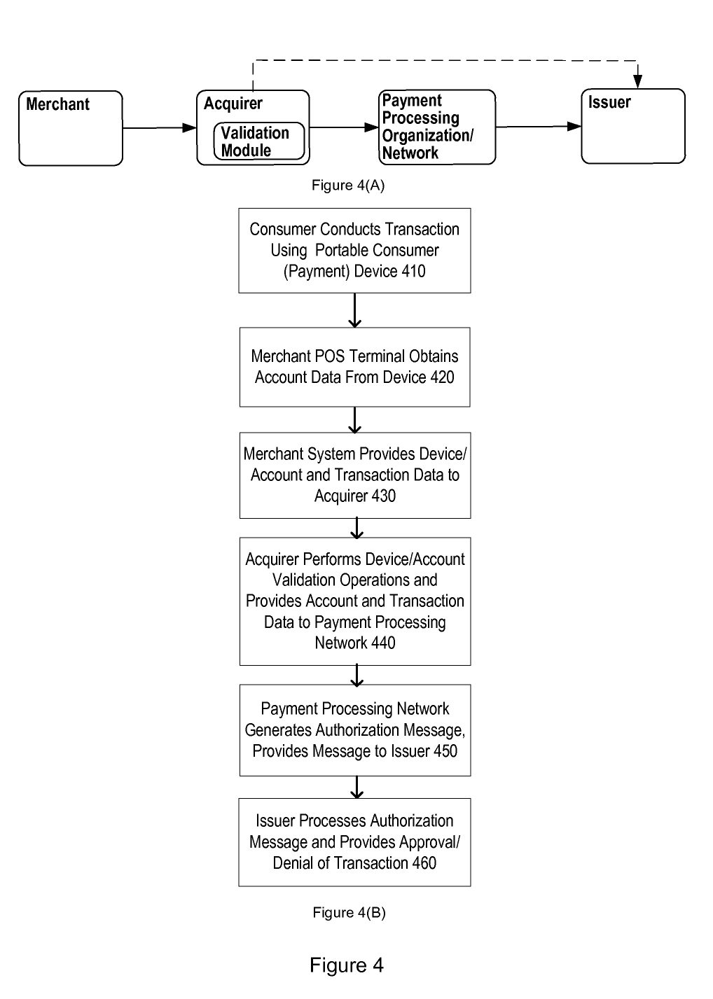

Although FIG. 3 illustrates the general system architecture and process flow of one or more embodiments of the invention, there are multiple ways in which the inventive system and process flow may be implemented. These typically differ in the location of the account or device validation/authentication operations, the order in which various entities interact with the data, and the ways in which data is communicated to the different elements of the system architecture. As noted, embodiments of the invention include multiple ways of implementing the account or device verification aspect of a transaction as it is conducted by a first entity, with the transaction authorization/processing operations being provided by a second and different entity. Some examples of possible system architectures and processing flows will now be described with reference to FIG. 4 through FIG. 11.

FIG. 4 is a flow diagram (FIG. 4(A)) and flow chart (FIG. 4(B)) illustrating the process flow for validating a payment account/device and authorizing a transaction in one embodiment of the present invention. In the embodiment shown in FIG. 4(A), the entity that developed the payment account/device verification operations or developed the payment device (or both) provides a functional module (identified as “validation module” in the figure, and which may take the form of executable code or a self-contained processing unit, for example) to the acquirer of the merchant that is conducting the transaction. The functional module enables the acquirer to implement one or more of the processes, functions, or operations involved in verifying the authenticity of the payment account or payment device. After performing the authentication operations, the results may be provided to the issuer for use in further processing of the transaction (as indicated by the dashed line in the figure). Note that an alternative is for the outcome of the authentication processing operations to be provided to the appropriate payment processing network for use in the network's authorization of the transaction (where such an organization would be positioned between the acquirer and the issuer, with the solid line in that case indicating a transfer of the authentication processing results and the other transaction data).

As shown in FIG. 4(B), the merchant transaction processing system provides the payment account data obtained from the portable consumer (payment) device and information about the proposed transaction to the merchant's acquirer (illustrated as 410, 420, 430). As mentioned, the acquirer or merchant may also obtain the payment account data from the consumer without use of a physical device. The acquirer implements an account/device validation/authentication process to verify that the device is authentic (440) and/or that the account is a valid account. This may be accomplished by accessing a module provided by the entity responsible for developing the device or establishing the account characteristics, under an appropriate license or business arrangement. The validation module may contain a set of executable instructions, which when executed by a suitably programmed central processing unit (CPU) or microprocessor may implement the processes, functions, or operations needed to properly authenticate the payment account or device.

In the case of a payWave device, for example, this may include verification that the generated cryptogram is an authentic one that would be generated by an authentic payWave device. After verifying the authenticity of the payment account/device, the acquirer provides confirmation of the account/device's authenticity to a payment processing organization that is responsible for participating in the authorization of the transaction (440). The payment processing organization generates a transaction authorization request message that is provided to the issuer of the payment account/device for processing to determine if the proposed transaction will be approved or denied (450). The issuer then determines whether to approve or deny the payment transaction (460). Thus, in this embodiment of the inventive system and process flow, the payment account/device authentication operations are performed independently and by a different entity than are the transaction authorization operations. In this example, the payment account/device may be authenticated by the acquirer using a process supplied by or licensed from the entity that developed the account/device (such as Visa or another entity that is different from the payment processing organization that performs the transaction authorization operations).

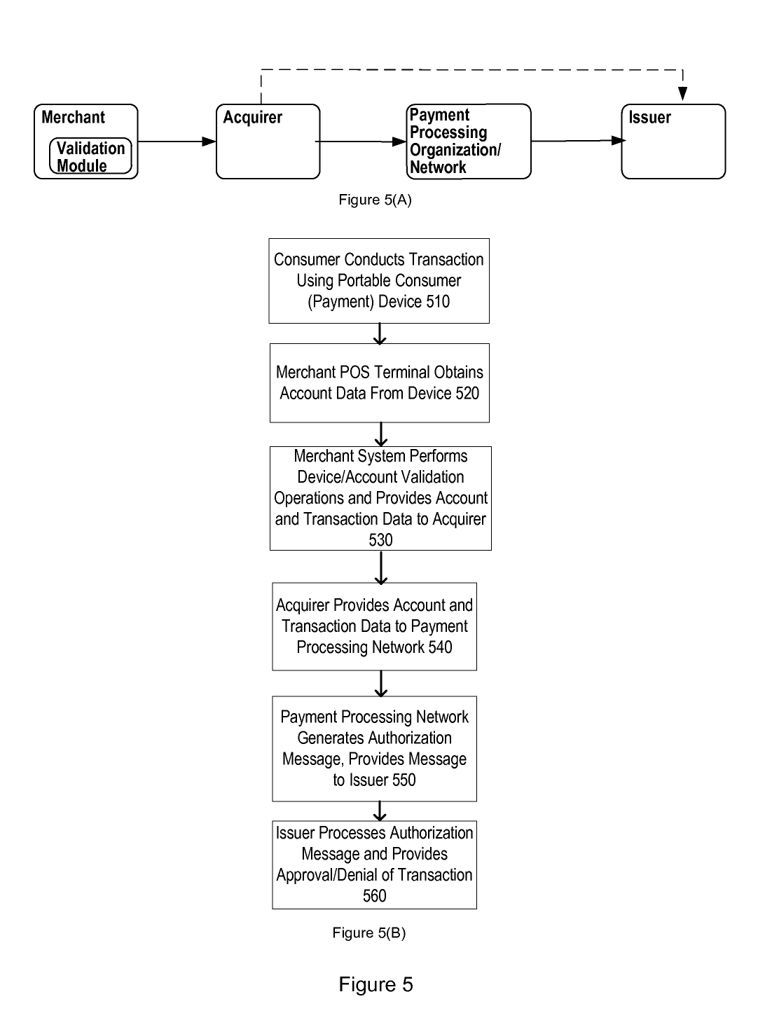

FIG. 5 is a flow diagram (FIG. 5(A)) and flow chart (FIG. 5(B)) illustrating the process flow for validating a payment account/device and authorizing a transaction in one embodiment of the present invention. In the embodiment shown in FIG. 5(A), the entity that developed the payment account/device verification operations or developed the payment device (or both) provides a functional module (identified as “validation module” in the figure) to the merchant that is conducting the transaction. The functional module implements one or more of the processes, functions, or operations involved in verifying the authenticity of the payment account or payment device. After performing the authentication operations, the results are provided to the acquirer which then provides them to the issuer for further processing of the transaction. Note that an alternative is for the outcome of the authentication operation to be provided to the appropriate payment processing network for use in the network's authorization of the transaction (where such an organization would be positioned between the acquirer and the issuer).

As shown in FIG. 5(B), the merchant transaction processing system provides the data obtained from the portable consumer (payment) device (or the consumer) and information about the proposed transaction to the merchant's acquirer (illustrated as 510, 520, 530). In addition, the merchant implements an account/device validation/authentication process to verify that the account/device is authentic (530). This may be accomplished by accessing a module provided by the entity responsible for developing the device or account characteristics, under an appropriate license or business arrangement. The validation module may contain a set of executable instructions, which when executed by a suitably programmed central processing unit (CPU) or microprocessor may implement the processes, functions, or operations needed to properly authenticate the payment account or payment device. In the case of a payWave device, for example, this may include verification that the generated cryptogram is an authentic one that would be generated by an authentic payWave device. After verifying the payment account/device, the merchant provides confirmation of the account/device's authenticity to the acquirer for further processing by the acquirer or by the payment processing organization that is responsible for participating in the authorization of the transaction. The acquirer then provides data regarding the account/device (such as an indication of the validity of the account or device and the account identifier) and the transaction to the payment processing organization/network (540). The payment processing organization/network generates a transaction authorization request message that is provided to the issuer for processing to determine if the proposed transaction will be approved or denied (550). The issuer then determines whether to approve or deny the payment transaction (560). Thus, in this embodiment of the inventive system and process flow, the payment account/device authentication operations are performed independently and by a different entity than are the transaction authorization operations. In this example, the payment account/device may be authenticated by the merchant using a process supplied by or licensed from the entity that developed the account/device (such as Visa or another entity that is different from the payment processing organization that performs the transaction authorization operations).

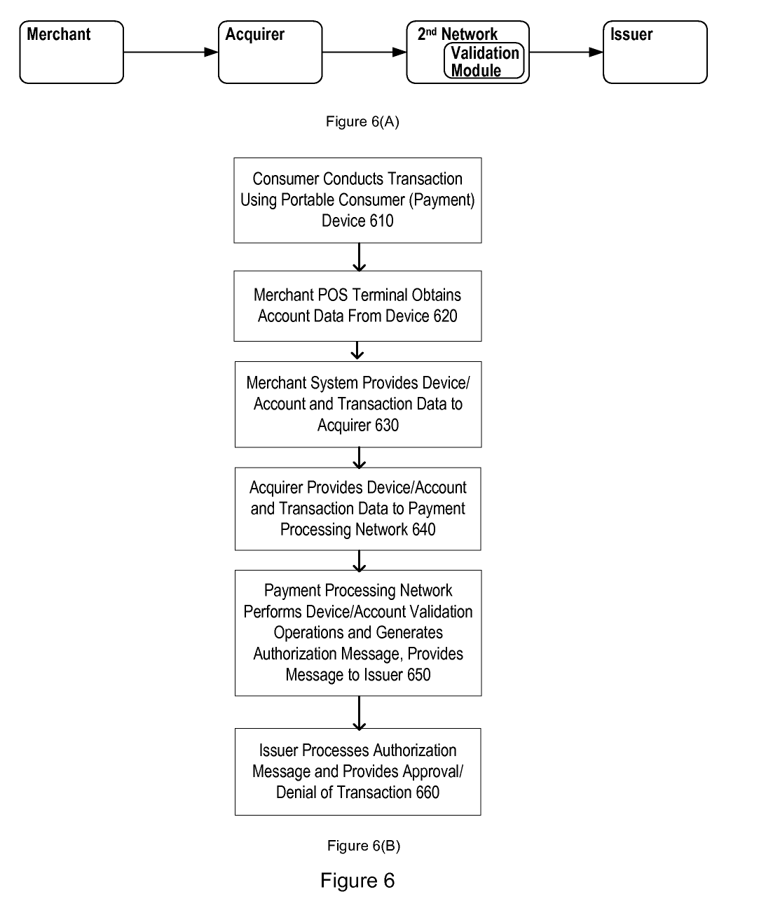

FIG. 6 is a flow diagram (FIG. 6(A)) and flow chart (FIG. 6(B)) illustrating the process flow for validating a payment account/device and authorizing a transaction in one embodiment of the present invention. In the embodiment shown in FIG. 6(A), the entity that developed the account/device verification operations or developed the payment device (or both) provides a functional module (identified as “validation module” in the figure) to a payment processing network that is responsible for participating in the authorization of the transaction (identified as “2^{nd} Network” in the figure to differentiate it from the operator of a first network that may have provided the verification module). The functional module implements one or more of the processes, functions, or operations involved in verifying the authenticity of the payment account or payment device. After performing the authentication operations, the results are provided to the issuer for further processing of the transaction. Note that in the example embodiment shown in FIG. 6(A), the 2^{nd} Payment Processing Network (or organization) participates in both the authentication and transaction authorization processes, with the authentication being performed by a functional module provided by or licensed from another entity (which in some cases may be a different payment processing organization/network).

As shown in FIG. 6(B), the merchant transaction processing system provides the data obtained from the portable consumer (payment) device (or the consumer) and information about the proposed transaction to the merchant's acquirer (illustrated as 610, 620, 630). The acquirer provides the received data and information to a payment processing network (labeled “2^{nd} Network” in the figure, and illustrated as 640). The payment processing network implements an account/device validation/authentication process to verify that the account/device is authentic (650). This may be accomplished by accessing a module provided by the entity responsible for developing the device or account characteristics, under an appropriate license or business arrangement. The validation module may contain a set of executable instructions, which when executed by a suitably programmed central processing unit (CPU) or microprocessor may implement the processes, functions, or operations needed to properly authenticate the payment account/device. In the case of a payWave device, for example, this may include verification that the generated cryptogram is an authentic one that would be generated by an authentic payWave device. After verifying the payment account/device, the 2^{nd} Network would provide confirmation of the account/device's authenticity to the transaction authorization processes being performed by the 2^{nd} Network. The 2^{nd} Network (i.e., the payment processing organization) then generates a transaction authorization request message that is provided to the issuer for processing to determine if the proposed transaction will be approved or denied (650). The issuer then determines whether to approve or deny the payment transaction (660). Thus, in this embodiment of the inventive system and process flow, the authentication operations are performed by the same entity as performs the transaction authorization operations; however, the authentication operations are performed by a module provided by the developer of the payment account/device which may be a different payment processing organization than the 2^{nd} Network. For example, the payment account/device may be authenticated by the 2^{nd} Network using a process supplied by or licensed from Visa (or another entity that is different from the 2^{nd} Network), where the 2^{nd} Network is the payment processing organization that performs the transaction authorization operations.

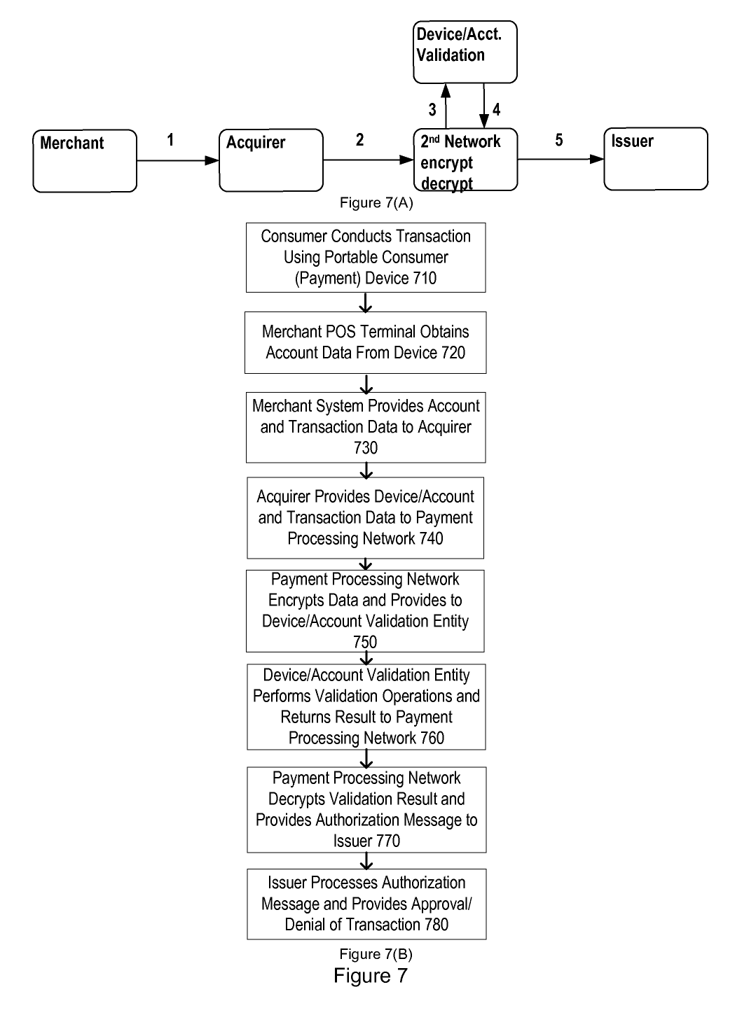

FIG. 7 is a flow diagram (FIG. 7(A)) and flow chart (FIG. 7(B)) illustrating the process flow for validating a payment account/device and authorizing a transaction in one embodiment of the present invention. In the embodiment shown in FIG. 7(A), the entity that performs the account/device verification operations (identified as “device/account validation” in the figure) receives data from a payment processing network that is responsible for participating in the authorization of the transaction (identified as “2^{nd} Network” in the figure to differentiate it from the operator of a first network that may be involved in the validation operations). The data provided by the 2nd Network is received from the acquirer (path 2), where the acquirer will typically have received data regarding the payment device and the transaction from the merchant (path 1). The data may be encrypted by the 2^{nd} Network prior to the data being provided to the device validation entity (along path 3, and which, as noted may be a different payment processing organization). The encryption method or protocol used may be any suitable method or process, including those typically used for transfer of financial data or other forms of confidential information. The account/device validation entity implements one or more of the processes, functions, or operations involved in verifying the authenticity of the payment account or payment device. After performing the authentication operations, the results are provided to the 2^{nd} Network (path 4) for further processing of the transaction (such as performing the transaction authorization processing). In the example embodiment shown in FIG. 7, the 2^{nd} Network may decrypt the device, transaction, and other data prior to providing the decrypted data to the issuer (path 5).

As shown in FIG. 7(B), the merchant transaction processing system provides the data obtained from the portable consumer (payment) device (or the consumer) and information about the proposed transaction to the merchant's acquirer (illustrated as 710, 720, 730). The acquirer provides the received data and information to a payment processing network (labeled “2^{nd} Network” in the figure, illustrated as 740). The payment processing network may then encrypt some or all of the data received from the acquirer and provide the data (whether encrypted or not) to the entity that implements the account/device validation/authentication process to verify that the account/device is authentic (750). The validation may be performed by the entity that developed the device or account characteristics, or by another entity that accesses a module provided by the entity that developed the account/device, under an appropriate license or business arrangement. The validation module may contain a set of executable instructions, which when executed by a suitably programmed central processing unit (CPU) or microprocessor may implement the processes, functions, or operations needed to properly authenticate the payment account or payment device. In the case of a payWave device, for example, this may include verification that the generated cryptogram is an authentic one that would be generated by an authentic payWave device. After verifying the payment account/device, the validation entity provides the results of the device verification process to the 2^{nd} Network (760), which then performs the transaction authorization processing, including generation of a transaction authorization request message (770). The 2^{nd} Network may decrypt the relevant account, device, transaction, and other relevant data received from the validation entity and generate a transaction authorization message that is provided to the issuer for processing to determine if the proposed transaction will be approved or denied (770). The issuer then determines whether to approve or deny the payment transaction (780). Thus, in this embodiment of the inventive system and process flow, the payment account/device authentication operations are performed by a different entity than the one that performs the transaction authorization operations.

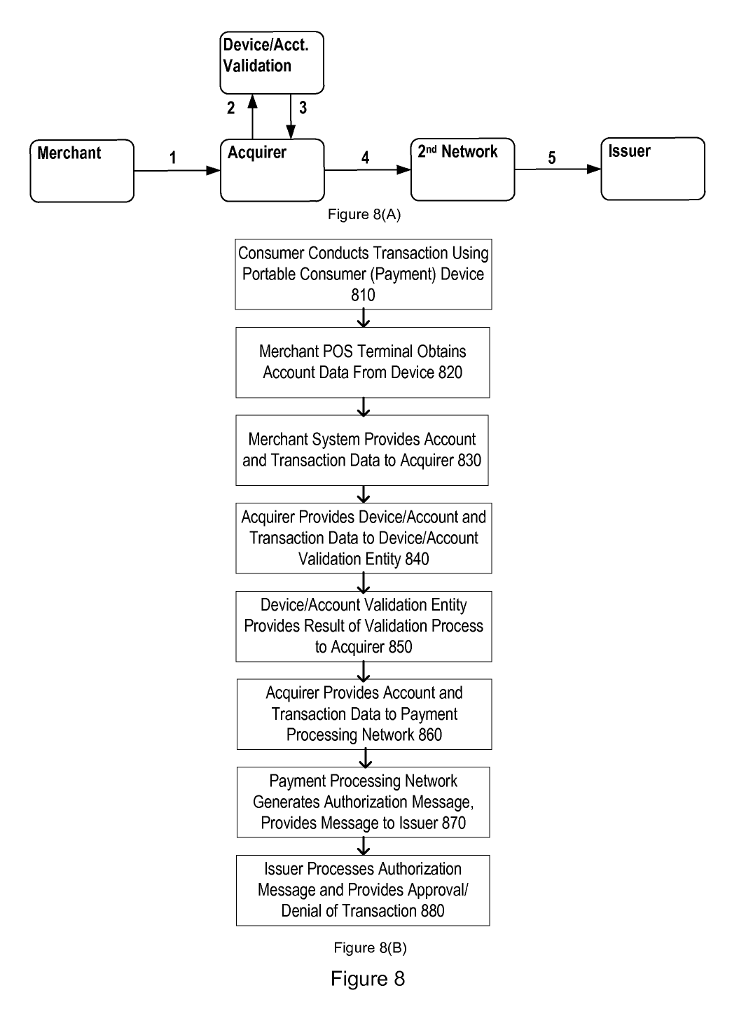

FIG. 8 is a flow diagram (FIG. 8(A)) and flow chart (FIG. 8(B)) illustrating the process flow for validating a payment account/device and authorizing a transaction in one embodiment of the present invention. In the embodiment shown in FIG. 8(A), the entity that performs the account/device verification/authentication function (identified as “device/account validation” in the figure) receives payment account/device data and, if required, transaction data from an acquirer that communicates with the merchant involved in the transaction (path 2), where the acquirer will typically have received data regarding the payment account/device and the transaction from the merchant (path 1). The entity responsible for performing the validation operations receives the relevant data or information from the acquirer (path 2) and implements one or more of the processes, functions, or operations involved in verifying the authenticity of the payment account or payment device. The result of the validation process is provided back to the acquirer (path 3) which then provides that data and other relevant device, account, or transaction data to a payment processing network (path 4) that is responsible for participating in the authorization of the transaction (identified as “2^{nd} Network” in the figure to differentiate it from the operator of a first network that may have participated in the validation process). The 2^{nd} Network provides a processed authorization request message to the issuer of the payment account/device for processing to determine if the transaction will be approved or denied (path 5).

As shown in FIG. 8(B), the merchant transaction processing system provides the data obtained from the portable consumer (payment) device (or the consumer) and information about the proposed transaction to the merchant's acquirer (illustrated as 810, 820, 830). The acquirer provides the relevant part of the received data and information to the device/account validation entity (840). The validation may be performed by the entity that developed the device or account characteristics, or by a different entity that accesses a module provided by the entity that developed the account/device, under an appropriate license or business arrangement. The validation module may contain a set of executable instructions, which when executed by a suitably programmed central processing unit (CPU) or microprocessor may implement the processes, functions, or operations needed to properly authenticate the payment account/device. In the case of a payWave device, for example, this may include verification that the generated cryptogram is an authentic one that would be generated by an authentic payWave device. After verifying the payment account/device, the validation entity provides the results of the verification process to the acquirer (850) which may perform further processing of the device, account, or transaction data before sending the data to a payment processing network (identified as “2^{nd} Network” in the figure) which performs the transaction authorization processing (860). The 2^{nd} Network typically would generate a transaction authorization request message that is provided to the issuer of the payment account/device for processing to determine if the proposed transaction will be approved or denied (870). The issuer then determines whether to approve or deny the payment transaction (880). Thus, in this embodiment of the inventive system and process flow, the authentication operations are performed by a different entity than the one that performs the transaction authorization operations.

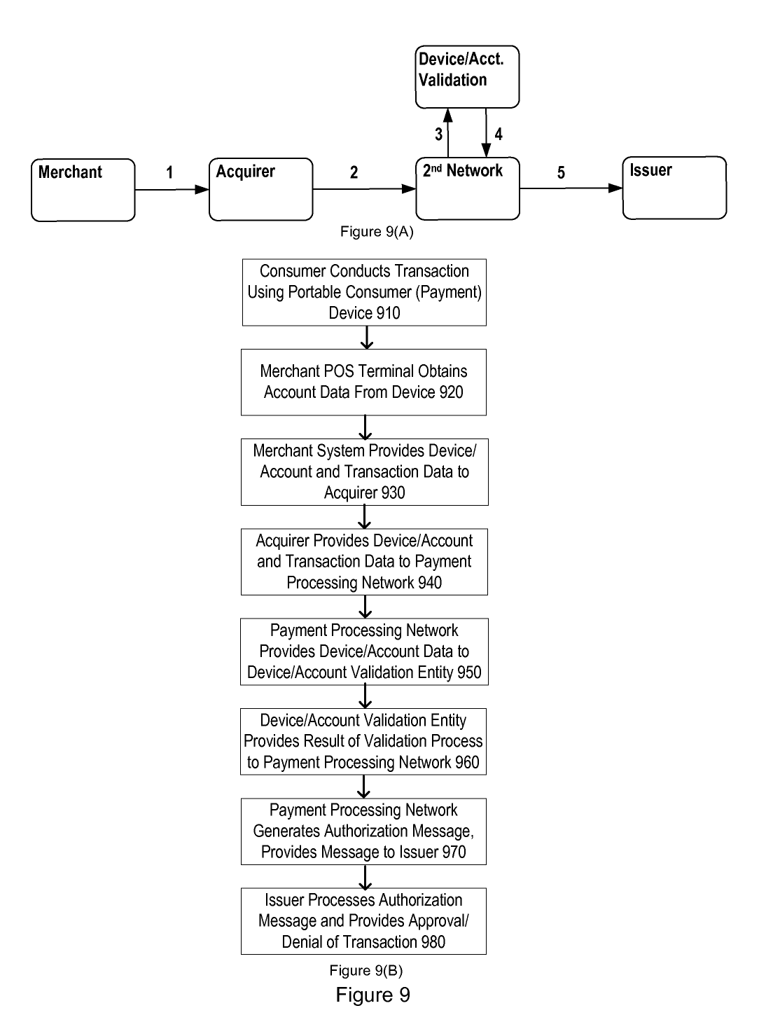

FIG. 9 is a flow diagram (FIG. 9(A)) and flow chart (FIG. 9(B)) illustrating the process flow for validating a payment account/device and authorizing a transaction in one embodiment of the present invention. In the embodiment shown in FIG. 9(A), the entity that performs the account or device verification function (identified as “device/account validation” in the figure) receives data from a payment processing network (illustrated as path 3) that is responsible for participating in the authorization of the transaction (identified as “2^{nd} Network” in the figure to differentiate it from the operator of a first network that may be involved in the validation operations). The data provided by the 2^{nd} Network is received from the acquirer (path 2, and which typically receives relevant data from the merchant along path 1) and provided to the validation entity (which, as noted may be a different payment processing organization). The validation entity implements one or more of the processes, functions, or operations involved in verifying the authenticity of the payment account or payment device. After performing the authentication operations, the results are provided to the 2^{nd} Network for further processing of the transaction (illustrated as path 4, where such further processing may include performing the transaction authorization processing). The 2^{nd} Network provides a processed transaction authorization request message to the issuer of the payment account/device for processing to determine if the transaction will be approved or denied (path 5).

As shown in FIG. 9(B), the merchant transaction processing system provides the data obtained from the portable consumer (payment) device (or the consumer) and information about the proposed transaction to the merchant's acquirer (910, 920, 930). The acquirer provides the received data and information to a payment processing network (940, labeled “2^{nd} Network” in the figure). The payment processing network may encrypt some of the data received from the acquirer before providing the relevant data to the entity that implements the account/device validation/authentication process to verify that the account or device is authentic (950). The validation may be performed by the entity that developed the device or account characteristics, or by another entity that accesses a module provided by the entity that developed the account/device, under an appropriate license or business arrangement. The validation module may contain a set of executable instructions, which when executed by a suitably programmed central processing unit (CPU) or microprocessor may implement the processes, functions, or operations needed to properly authenticate the payment account/device. In the case of a payWave device, for example, this may include verification that the generated cryptogram is an authentic one that would be generated by an authentic payWave device. After verifying the payment account/device, the validation entity provides the results of the verification process to the 2^{nd} Network (960), which then performs the transaction authorization processing. If necessary, the 2^{nd} Network may decrypt the relevant account, device, transaction, or other relevant data received from the validation entity before generating a transaction authorization request message that is provided to the issuer for processing to determine if the proposed transaction will be approved or denied (970). The issuer then determines whether to approve or deny the payment transaction (980). Thus, in this embodiment of the inventive system and process flow, the payment account/device authentication operations are performed by a different entity than the one that performs the transaction authorization operations.

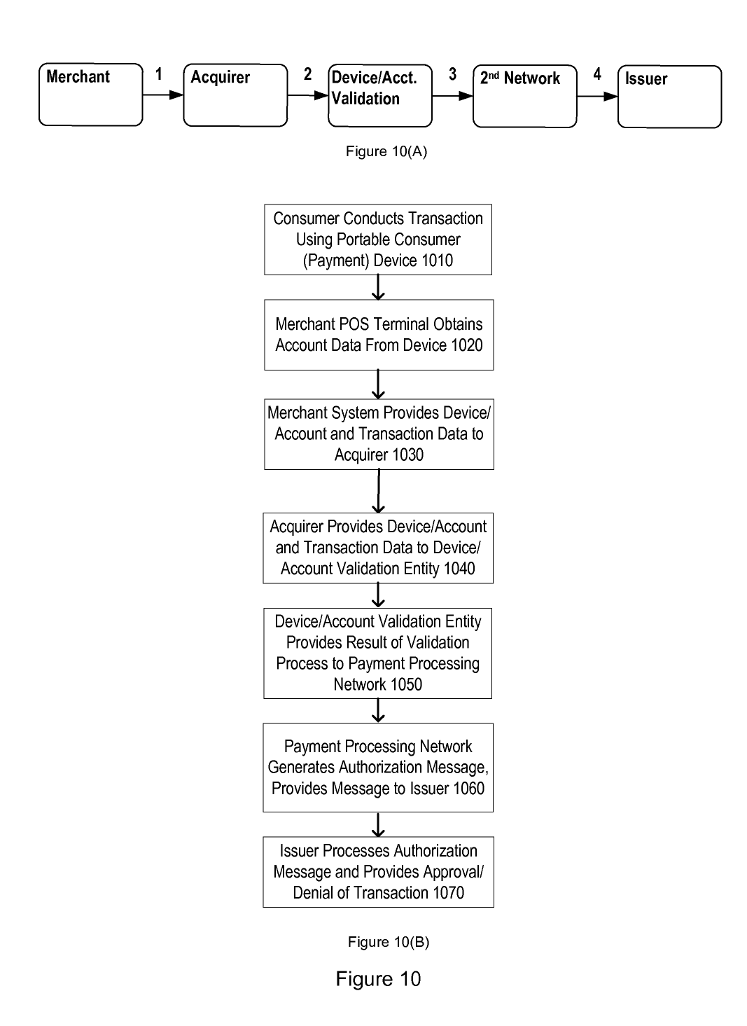

FIG. 10 is a flow diagram (FIG. 10(A)) and flow chart (FIG. 10(B)) illustrating the process flow for validating a payment account/device and authorizing a transaction in one embodiment of the present invention. In the embodiment shown in FIG. 10(A), the entity that performs the account/device verification function (identified as “device/account validation” in the figure) receives payment account/device data and if required, transaction data from an acquirer (illustrated as path 2) that communicates with the merchant involved in the transaction (path 1). In contrast to the embodiment described with reference to FIG. 8, in the embodiment depicted in FIG. 10, the acquirer completes its processing of the data received from the merchant system before it is provided to the validation entity. The validation entity receives the relevant data or information from the acquirer (path 2) and implements one or more of the processes, functions, or operations involved in verifying the authenticity of the payment account/device. The result of the validation process is provided to a payment processing network (path 3) that is responsible for participating in the authorization of the transaction (identified as “2^{nd} Network” in the figure to differentiate it from the operator of a first network that may have participated in the validation process). The 2^{nd} Network provides a processed authorization request message to the issuer of the payment account/device for processing to determine if the transaction will be approved or denied (path 4).

As shown in FIG. 10(B), the merchant transaction processing system provides the data obtained from the portable consumer (payment) device (or the consumer) and information about the proposed transaction to the merchant's acquirer (1010, 1020, 1030). The acquirer performs its processing of the received data and provides the processed data and information to the validation entity (1040). The validation may be performed by the entity that developed the account/device, or by another entity that accesses a module provided by the entity that developed the account/device, under an appropriate license or business arrangement. The validation module may contain a set of executable instructions, which when executed by a suitably programmed central processing unit (CPU) or microprocessor may implement the processes, functions, or operations needed to properly authenticate the payment account/device. In the case of a payWave device, for example, this may include verification that the generated cryptogram is an authentic one that would be generated by an authentic payWave device. After verifying the payment account/device, the validation entity provides the results of the verification process to a payment processing network (identified as “2^{nd} Network” in the figure) which performs the transaction authorization processing (1050). The 2^{nd} Network typically would generate a transaction authorization request message that is provided to the issuer of the payment account/device for processing to determine if the proposed transaction will be approved or denied (1060). The issuer then determines whether to approve or deny the payment transaction (1070). Thus, in this embodiment of the inventive system and process flow, the payment account/device authentication operations are performed by a different entity than the one that performs the transaction authorization operations.

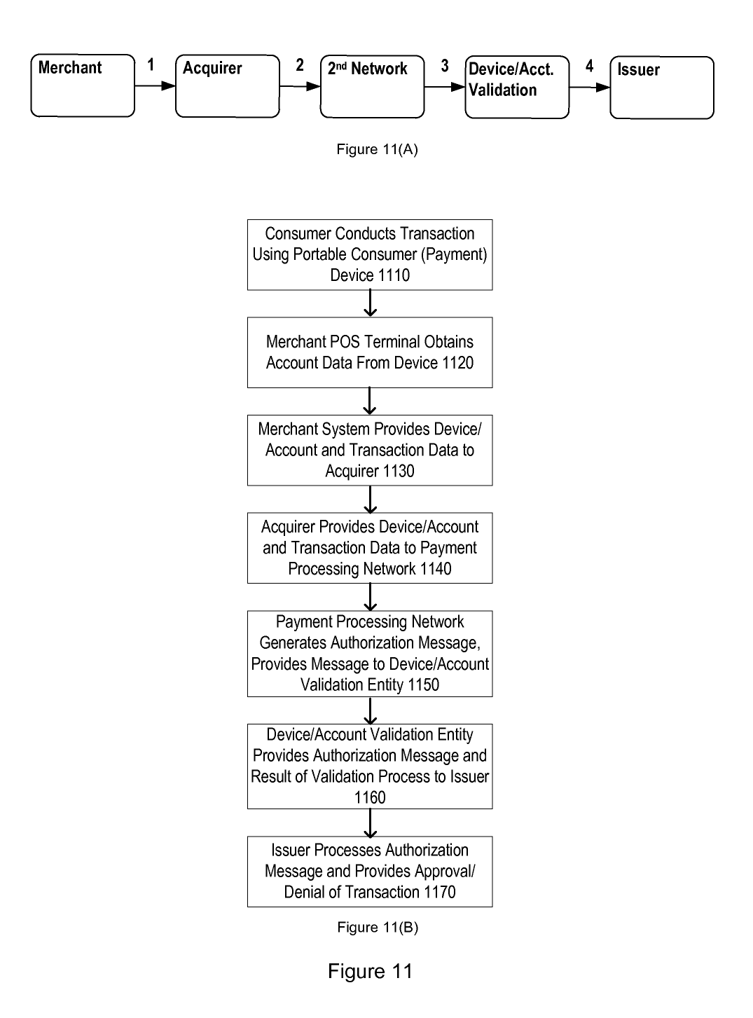

FIG. 11 is a flow diagram (FIG. 11(A)) and flow chart (FIG. 11(B)) illustrating the process flow for validating a payment account/device and authorizing a transaction in one embodiment of the present invention. In the embodiment shown in FIG. 11(A), the entity that performs the verification function (identified as “device/account validation” in the figure) receives a transaction authorization request message (and may receive other payment account/device data and/or transaction data) from a payment processing network (path 3) that performs the data processing involved in the authorization process for the transaction (identified as “2^{nd} Network” in the figure to differentiate it from the operator of a first network that may have participated in the validation process). The 2^{nd} Network will typically have received messages, data, or other forms of information from the merchant (path 1) via the acquirer and/or the acquirer (path 2). In contrast to the embodiment described with reference to FIG. 10, in the embodiment depicted in FIG. 11, the validation entity is situated in the process flow after the payment processing network, instead of prior to it. The validation entity receives the relevant data or information from the payment processing network (path 3) and implements one or more of the processes, functions, or operations involved in verifying the authenticity of the account/device. The result of the validation process is provided (along with the transaction authorization request message or data representing that message) to the issuer for processing to determine if the transaction will be approved or denied (path 4).

As shown in FIG. 11(B), the merchant transaction processing system provides the data obtained from the portable consumer (payment) device (or the consumer) and information about the proposed transaction to the merchant's acquirer (1110, 1120, 1130). The acquirer performs its processing of the received data and provides the processed data and information to the payment processing network (1140). The payment processing network processes the received data to perform its role in the transaction processing and authorization processes, after which the payment processing network provides the transaction authorization request message and/or payment account/device and transaction data to the validation entity (1150). The validation may be performed by the entity that developed the account/device, or by another entity that accesses a module provided by the entity that developed the account/device, under an appropriate license or business arrangement. The validation module may contain a set of executable instructions, which when executed by a suitably programmed central processing unit (CPU) or microprocessor may implement the processes, functions, or operations needed to properly authenticate the payment account/device. In the case of a payWave device, for example, this may include verification that the generated cryptogram is an authentic one that would be generated by an authentic payWave device. After verifying the payment account/device, the validation entity provides the results of the verification process (and possibly other data, such as the result of the transaction authorization processing performed by the 2^{nd} Network) to the issuer of the payment account/device for processing to determine if the proposed transaction will be approved or denied (1160). The issuer then determines whether to approve or deny the payment transaction (1170). Thus, in this embodiment of the inventive system and process flow, the authentication operations are performed by a different entity than the one that performs the transaction authorization operations.

Note that in the embodiments of the invention described with reference to FIGS. 3 through 11, the entity that performs the authentication of the portable consumer device and/or the payment account may be different from the entity that performs the processes related to authorization and/or processing of a transaction conducted using the account or device. This decoupling of the two processes (validation/authentication and transaction authorization/processing) provides benefits to consumers, merchants, and issuers by enabling the selection of a desired device or account characteristics separately from that of a payment processing network or organization. This permits the selection of a portable consumer device or payment account that incorporates desirable features (e.g., functions related to security, tracking, ease of use, loyalty programs, etc.) independently of the selection of the payment processing network used to process the transaction. Similarly, it enables selection of a desired payment processing network for transaction processing (due to relative costs, interchange rates, incentives, administrative benefits, etc.) independently of the selection of a particular device or account. This enables multiple inventive data processing flows in which the validation and transaction authorization operations are performed by different entities in multiple possible configurations (i.e., where the order of the two sets of operations are varied and the data flow may include different nodes, etc.).

Embodiments of the invention (such as those described with reference to FIGS. 3-11) provide a technical solution to a technical problem. Among the problems solved by the invention is the need to provide improved security for payment transactions in order to increase the use of contactless payment devices. Increasing the adoption of contactless payment devices provides consumers with many benefits, and adoption depends to some extent on the security level that is perceived to exist for such transactions. Embodiments of the invention also provide a solution to the technical problem of integrating a specific type of consumer payment device or payment account with a payment processing network, where the device or account was developed independently of that network. Embodiments of the invention provide a solution to these and other problems by decoupling the authentication/validation operations from the transaction authorization/processing operations, as illustrated in one or more of the inventive process flows.

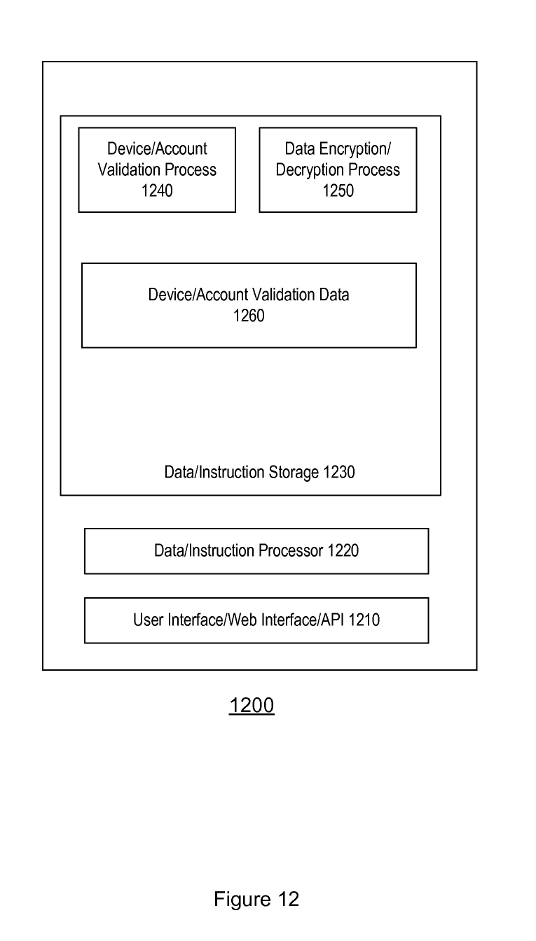

FIG. 12 is a diagram illustrating certain functional elements of a Portable Consumer (Payment) Account or Device Validation/Authentication Entity 1200 (such as is identified as “Device/Account Validation” in the figures) that may be used in implementations of an embodiment of the present invention. In some embodiments, the data or messages provided to entity 1200 may be submitted by accessing a suitable interface or communications channel (such as a user interface, web-page, web interface, API, etc.). The element identified as “User Interface/Web Interface/API 1210” in FIG. 12 represents some or all of the elements that may be used to provide data, messages, or information to the validation entity.

In some embodiments, account/device validation/authentication entity 1200 may be implemented as an element of a system or apparatus and include a processing element, central processing unit (CPU), microprocessor, or other element operative to execute a set of instructions (identified as “Data/Instruction Processor 1220” in the figure). The processor is programmed with a set of instructions stored in a suitable data storage or memory (identified as “Data/Instruction Storage 1230” in the figure). When the instructions are executed by the programmed processor, the validation entity operates to perform one or more of the processes, operations, or methods that are part of the present invention. The storage element may also store data that is used by the processor to perform the inventive processes, operations, or methods. Such data may include information about the payment device that was used to conduct a transaction, the security protocols related to the device, characteristics of the payment account, or other information relevant to the performance of the authentication process.

The executable instructions or data stored in Data/Instruction Storage element 1230 may include executable instructions for one or more processes, functions, operations, or methods. For example, the instructions may include instructions which, when executed, implement a device/account validation process 1240, a data encryption or decryption process 1250, or another relevant process used to validate a payment account or payment device (where the data operated on by such processes may be contained in a data storage such as that identified by “Device/Account Validation Data 1260” in the figure). For example, the executable instructions may cause the processor to determine if a received cryptogram is valid, or if another characteristic of the received data indicates that the payment account or payment device is valid or is not valid.

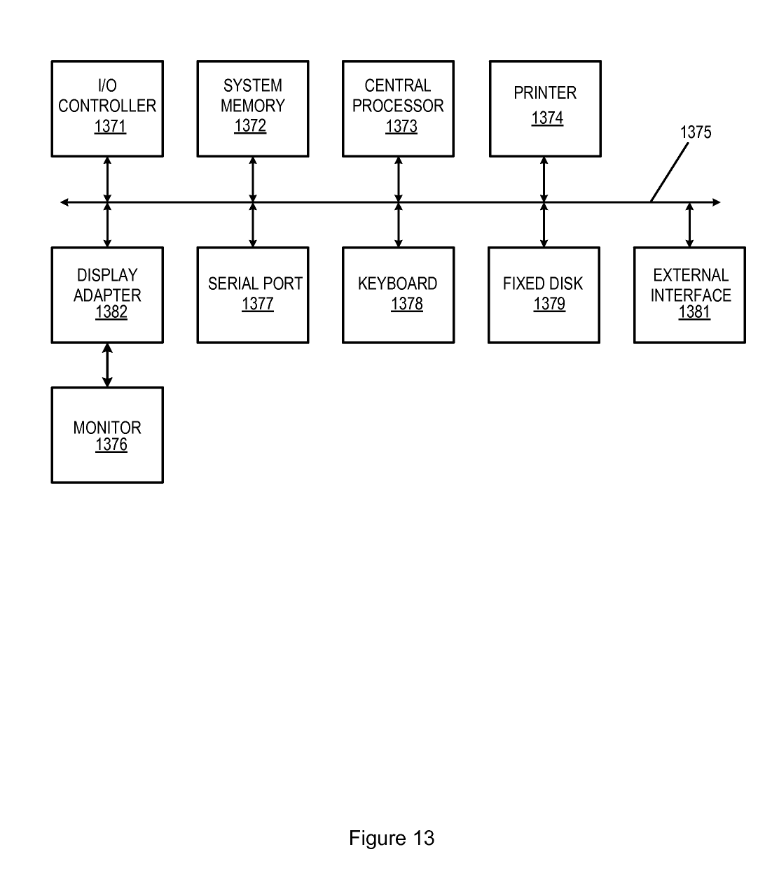

As noted, in some embodiments, the inventive methods, processes or operations may be wholly or partially implemented in the form of a set of instructions executed by a suitably programmed central processing unit (CPU) or microprocessor. The CPU or microprocessor may be incorporated in an apparatus, server or other data processing device operated by, or in communication with, one or more nodes of the overall transaction processing network (such as a validation entity, acquirer, or an element of a payment processing organization's network). As an example, FIG. 13 is a block diagram of elements that may be present in a computing device or system configured to execute a method or process in accordance with some embodiments of the present invention. The subsystems shown in FIG. 13 are interconnected via a system bus 1375. Additional subsystems such as a printer 1374, a keyboard 1378, a fixed disk 1379, a monitor 1376, which is coupled to a display adapter 1382, and others are shown. Peripherals and input/output (I/O) devices, which couple to an I/O controller 1371, can be connected to the computing system by any number of means known in the art, such as a serial port 1377. For example, the serial port 1377 or an external interface 1381 can be used to connect the computing device to a wide area network such as the Internet, a mouse input device, or a scanner. The interconnection via the system bus 1375 allows a central processor 1373 to communicate with each subsystem and to control the execution of instructions that may be stored in a system memory 1372 or the fixed disk 1379, as well as the exchange of information between subsystems. The system memory 1372 and/or the fixed disk 1379 may embody a computer readable medium.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

While certain exemplary embodiments have been described in detail and shown in the accompanying drawings, it is to be understood that such embodiments are merely illustrative of and not intended to be restrictive of the broad invention, and that this invention is not to be limited to the specific arrangements and constructions shown and described, since various other modifications may occur to those with ordinary skill in the art.

As used herein, the use of “a”, “an” or “the” is intended to mean “at least one”, unless specifically indicated to the contrary.

What is claimed is:

1. A method of processing a payment transaction, comprising:
performing, by an entity, an authentication process on payment account data for a payment account used to conduct the payment transaction by processing the payment account data to generate an indication of whether the payment account is a valid payment account;
performing, by a payment processing network, a transaction processing operation by processing data regarding the payment transaction, the transaction processing operation being other than the authentication process to generate an indication of whether the payment account is a valid payment account that is performed by the entity, the payment processing network being operated by a payment processing organization that is different from the entity performing the authentication process; and
providing the results of the processing by the entity and the processing by the payment processing network to an issuer to enable the issuer to approve or deny the payment transaction.

2. The method of claim 1, wherein the entity is a payment processing network operated by a payment processing organization that is different from the payment processing organization that operates the payment processing network that performs the transaction processing operation.

3. The method of claim 1, wherein the entity further performs an authentication process on a portable consumer device used by a consumer to conduct the payment transaction.

4. The method of claim 3, wherein the authentication process performed by the entity on the portable consumer device includes processing a received cryptogram to verify that the device is an authentic device.

5. The method of claim 1 wherein the transaction processing operation performed by the payment processing network includes generating a transaction authorization request message for the payment transaction.

6. The method of claim 1, wherein the entity processes the payment account data to generate the indication of whether the payment account is a valid payment account by evaluating one or more of:
(a) account usage statistics to determine an indication of unusual activity within the account as represented by the payment transaction or previous payment transactions;
(b) an IP address or other indication of the source of the payment transaction;
(c) a response to a challenge or security question presented to a consumer conducting the payment transaction;
(d) data related to the type of payment transaction;
(e) a presence or absence of certain data in data provided by a payment device or by the consumer; or
(f) indicia of the payment account, the consumer, a merchant, or the payment transaction that suggests an attempt to commit a fraudulent payment transaction.

7. The method of claim 1, wherein the entity is an acquirer.

8. The method of claim 1, wherein the entity is a merchant.

9. The method of claim 1, wherein the entity is communicatively coupled to the payment processing network and receives the data used in the authentication process from the payment processing network.

10. A system for processing a payment transaction, comprising:
a merchant data processing system configured to receive payment account data from a consumer and in response to generate a request for authorization of the payment transaction;
an entity configured to receive the payment account data and to process the received data to determine whether the payment account is a valid payment account;
a payment processing network operated by a payment processing organization and configured to receive the request for authorization of the payment transaction and to process the request to determine if the payment transaction should be authorized; and
an issuer configured to receive an output from the entity and from the payment processing network and to process the received outputs to determine whether to approve or deny the payment transaction.

11. The system of claim 10, wherein the entity further performs an authentication process on a portable consumer device used by the consumer to conduct the payment transaction by determining whether a cryptogram received from the device is valid.

12. The system of claim 10, wherein the entity is a payment processing network operated by a payment processing organization that is different from the payment processing organization that operates the payment processing network configured to receive the request for authorization of the payment transaction and to process the request to determine if the payment transaction should be authorized.

13. The system of claim 10, wherein the entity is an acquirer.

14. The system of claim 10, wherein the entity is a merchant.

15. The system of claim 10, further comprising an account authentication module configured to perform an authentication process to determine if the payment account is a valid payment account, and further, wherein the module is operated by the entity.

16. The system of claim 10, wherein the entity processes the received data to determine whether the payment account is a valid payment account by evaluating one or more of:
(a) account usage statistics to determine an indication of unusual activity within the account as represented by the payment transaction or previous payment transactions;
(b) an IP address or other indication of the source of the payment transaction;
(c) a response to a challenge or security question presented to a consumer conducting the payment transaction;
(d) data related to the type of payment transaction;
(e) a presence or absence of certain data in data provided by a payment device or by the consumer; or
(f) indicia of the payment account, the consumer, a merchant, or the payment transaction that suggests an attempt to commit a fraudulent payment transaction.

17. A method of processing a payment transaction, comprising:
receiving, from a first payment processing network operated by a first payment processing organization, confirmation that a payment account used to conduct the payment transaction is a valid payment account;
processing, by a second payment processing network operated by a second payment processing organization, an authorization request message for the payment transaction to determine if the payment transaction is authorized; and
providing the confirmation that the payment account is a valid payment account and the determination of whether the payment transaction is authorized to an issuer.

18. The method of claim 17, further comprising the issuer processing the confirmation that the payment account is a valid payment account and the determination of whether the payment transaction is authorized to determine whether to approve or deny the payment transaction.

19. The method of claim 17, wherein the confirmation that the payment account used to conduct the payment transaction is a valid payment account is received from the first payment processing network by the second payment processing network.

20. The method of claim 17, further comprising performing an authentication process on a portable consumer device used to conduct the payment transaction by processing a cryptogram received from the device to verify that it is valid.
